(19) United States
(12) Patent Application Publication
(10) Pub. No.: US 2007/0006466 A1
(43) Pub. Date: Jan. 11, 2007

(54) Knife

(75) Inventor: Qiu Jian Ping, Hangzhou (CN)

Correspondence Address: WILLIAM COLLARD;COLLARD & ROE, P.C., 1077 NORTHERN BOULEVARD, ROSLYN, NY, 11576, US

(73) Assignee: Great Neck Saw Manufacturers, Inc.

(21) Appl. No.: 11/178,888

(22) Filed: Jul. 11, 2005

(51) Int. Cl. B26B 1/02

(52) U.S. Cl. 30/152; 30/155

(57) ABSTRACT

A knife having a handle with a pair of ends and a knife assembly pivotally mounted on each end for movement from a folded to an unfolded position. The handle has a space adapted to receive the knife assemblies when the knife assemblies are in the folded positions. Each knife assembly having a blade at one end and tang at the other end with the tang having a lock edge. A lock sleeve is mounted within the handle and has a body and a pair of spring lock fingers which are biased in opposite directions away from the plane of the body of the lock sleeve. Each of the spring lock fingers has a lock shoulder adapted to cooperate with the lock edge of said knife assemblies when the knife assemblies are in their unfolded position to at least assist to hold the knife assemblies in their unfolded position.

### BACKGROUND

The present invention relates to knives and more particularly to a folding knife having blades extending from each end of the knife handle.

Such folding knives have been used for a number of years and usually comprise a knife blade assembly pivotally mounted on the opposite ends of a handle. Such knife blade assemblies are moved from a folded position within the handle to an extended position. Many of such folding knives have complicated structures, are difficult to use and maintain and are complicated and expensive to manufacture.

### OBJECTS

The present invention overcomes these drawbacks and has for one of its objects the provision of an improved knife having blade assemblies pivotally mounted at each end of its handle.

Another object of the present invention is the provision of an improved knife in which improved means are provided for holding the blade assemblies in an extended position.

Another object of the present invention is the provision of an improved knife which has improved means for holding the blade assemblies in a folded position.

Another object of the present invention is the provision of an improved knife in which the blade of at least one of the blade assemblies is easily removable and easily replaceable.

Another object of the present invention is the provision of an improved knife which is simple and inexpensive to manufacture.

Another object of the present invention is the provision of an improved knife which is simple to use and to maintain.

Other and further objects of the invention will be obvious upon an understanding of the illustrative embodiment about to described, or will be indicated in the appended claims and various advantages not referred to herein will occur to one skilled in the art upon employment of the invention in practice.

### DRAWINGS

A preferred embodiment of the invention has been chosen for purposes of illustration and description and is shown in the accompanying drawings forming a part of the specification, wherein:

FIG. 1 is a perspective view of a knife made in accordance with the present invention showing the blade assemblies in an unfolded position.

FIG. 2 is an exploded view thereof.

FIG. 3 is a top plan view thereof.

FIG. 3A is a bottom plan view thereof.

FIG. 4 is a side view showing one side of the knife.

FIG. 5 is a sectional view taken along line 5-5 of FIG. 4.

FIG. 6 is a sectional view taken along line 6-6 of FIG. 4.

FIG. 7 is a sectional view taken along line 7-7 of FIG. 3

FIG. 8 is a sectional view similar to FIG. 7 showing the blade assemblies in a partially folded position.

FIG. 9 is a sectional view similar to FIGS. 7 and 8 showing the blade assemblies in a fully folded position.

FIG. 10 is a partial bottom view of one end of the knife showing the position of the parts when the blade assembly is in the unfolded position shown in FIG. 7.

FIG. 10A is a partial bottom view similar FIG. 10 showing the position of the parts when the blade assembly is in the partially folded position shown in FIG. 8.

FIG. 10B is a partial bottom view similar to FIGS. 10 and 10A showing the position of the parts when the blade assembly is in the fully folded position shown in FIG. 9.

FIG. 11 is a partial bottom view of the other end of the knife showing the position of the parts when the blade assembly is in the unfolded position shown in FIG. 7.

FIG. 11A is partial bottom view similar to FIG. 11 showing the position of the parts when the blade assembly is in the partially folded position shown in FIG. 9.

FIG. 11B is a bottom view similar to FIGS. 11 and 11A showing the position of the parts when the blade assembly is in a fully folded position.

FIG. 12 is a simplified plan view showing the manner of removing a blade from one of the blade assemblies.

FIG. 13 is a side view showing the other side of the knife.

FIG. 14 is a perspective view of another embodiment of the present invention showing the blade assemblies in an unfolded position.

FIG. 15 is an exploded view thereof.

FIG. 16 is a top view thereof.

FIG. 16A is a bottom view thereof.

FIG. 17 is a side view thereof showing one side of the knife.

FIG. 18 is a sectional view taken along line 18-18 of FIG. 17.

FIG. 19 is a sectional view taken along line 19-19 of FIG. 17.

FIG. 20 is a sectional view taken along line 20-20 of FIG. 16.

FIG. 21 is a sectional view similar to FIG. 20 showing the blade assemblies in a partially folded position.

FIG. 22 is a sectional view similar to FIG. 20 showing the blade assemblies in a fully folded position.

FIG. 23 is a partial bottom view of one end of the knife showing the position of the parts when the blade assembly is in the fully extending position shown in FIG. 20.

FIG. 23A is a partial bottom view similar to FIG. 23 showing the position of the parts when the blade assembly is in the partially folded position shown in FIG. 21.

FIG. 23B is a partial bottom view similar to FIGS. 23 and 23A showing the position of the parts when the blade assembly is in the fully folded position shown in FIG. 22.

FIG. 24 is a partial bottom view of the other end of the knife showing the position of parts when the blade assembly is in the fully extended position shown in FIG. 20.

FIG. 24A is a partial bottom similar view to FIG. 24 showing the position of the parts when the blade assembly is in the partially folded position shown in FIG. 21.

FIG. 24B is a partial bottom view similar to FIGS. 24 and 24A showing the position of the parts when the blade is in the fully folded position shown in FIG. 22.

FIG. 25 is a simplified plan view showing the manner of removing a blade from one of the blade assemblies.

FIG. 26 is a side view showing the other side of the knife.

### DESCRIPTION

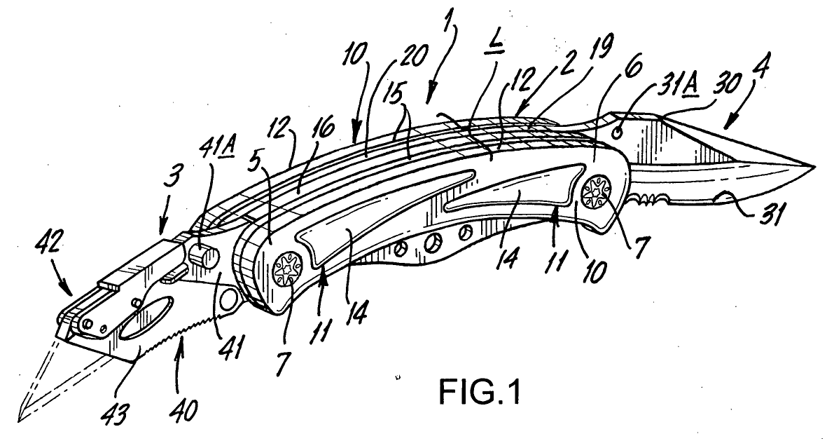

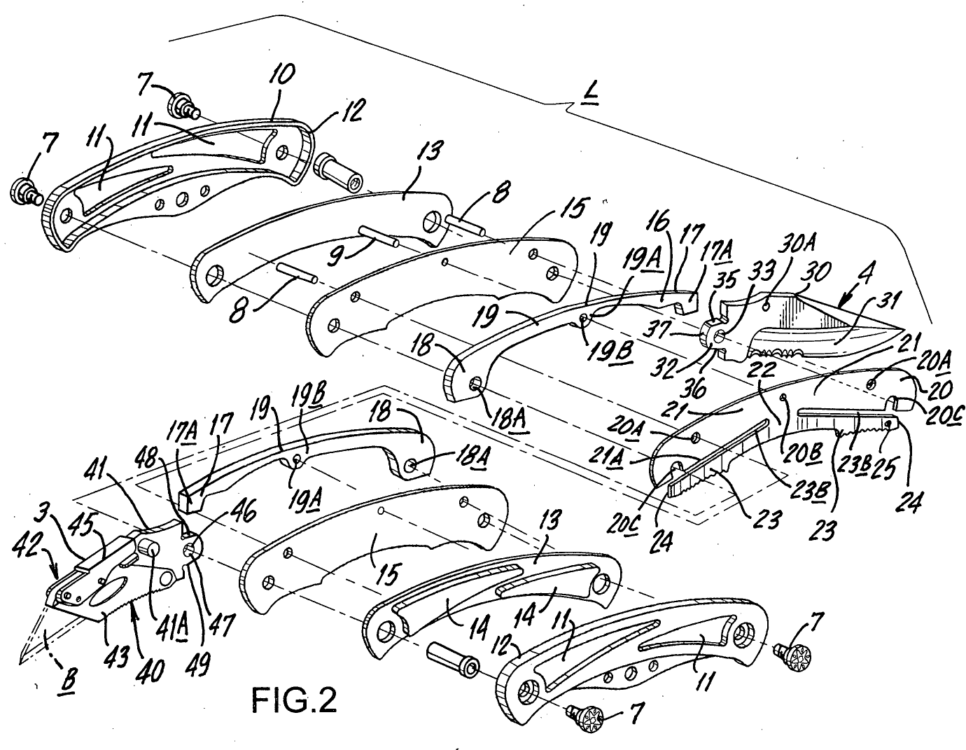

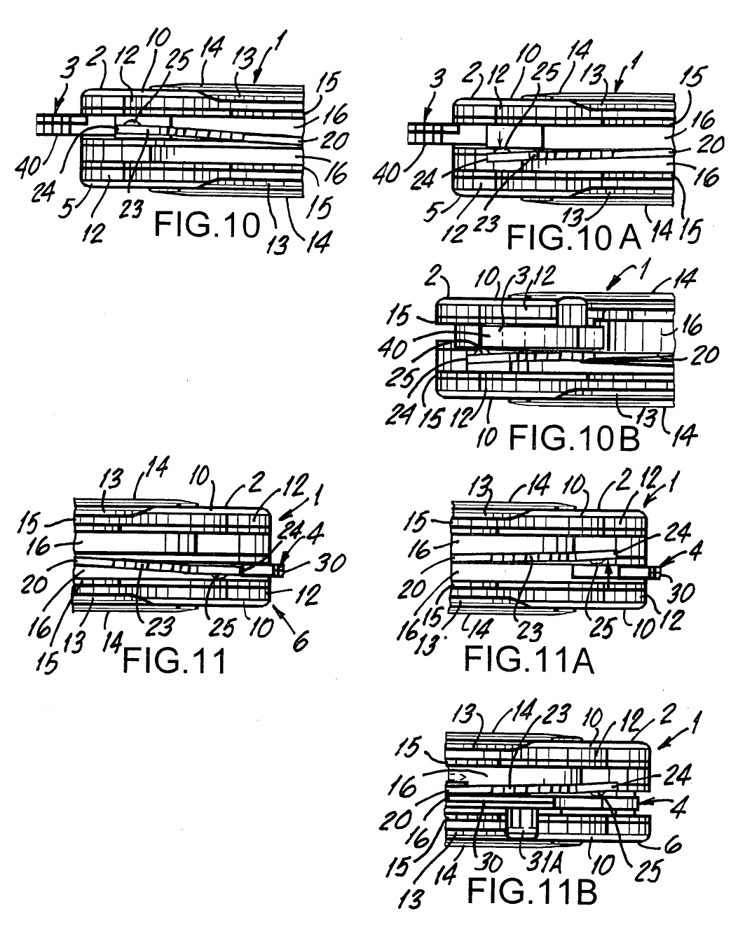

Referring to the drawings, and more particularly to the embodiment of the invention shown in FIGS. 1 to 13, the present invention comprises a knife 1 having a handle 2 and a pair of blade assemblies 3 and 4 which are pivotally mounted to opposed ends 5 and 6 of the handle 2 by means of pivot assemblies 7.

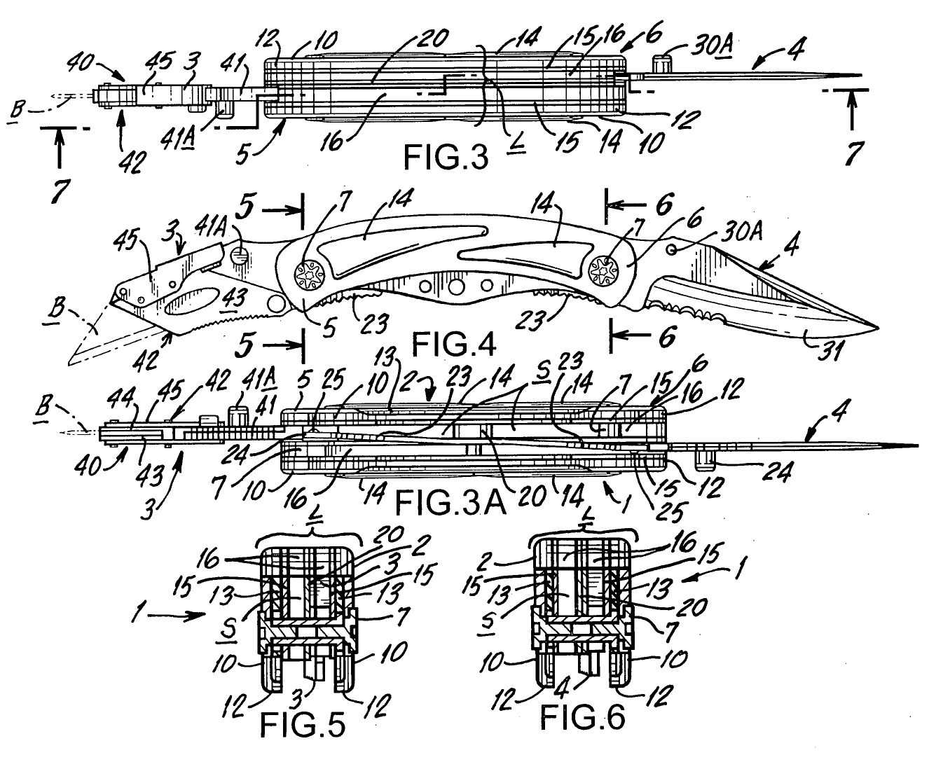

The handle 2 is comprised of a laminate assembly L comprising a plurality of laminates which are held together by the pivot assemblies 7 and by holding pins 8 and 9 which extend through the laminate assembly L. A central lock sleeve 20 is provided at the center of the laminate assembly L. A pair of outer laminates 10 have openings 11 (which may be decoratively shaped) and a peripheral wall 12 adapted to receive therein opposed decorative laminates 13 with raised decorations 14 which extend through the openings 11 in the outer laminates 10 and which fit within the outer wall 12. A pair of opposed inner laminates 15 are provided and bear against the decorative laminates 13. A pair of opposed spacers 16 are mounted between the inner laminates 15 and the center lock laminate 20 adjacent to the upper edge of the laminate assembly L to provide opposed spaces S (FIG. 3A) therebelow within the handle 2 which are adapted to receive the blade assemblies 3 and 4 when they are in their folded positions. The central lock sleeve 20 is interposed between the spacers 16. In brief, the laminate assembly L comprises opposed pairs of laminates 10, 13, 15 and the spacers 16 on each side of the central lock sleeve 20.

Each spacer 16 comprises a front end 17, a rear end 18 and a center portion 19. The rear end 18 has an opening 18A through which the pivot assembly 7 passes in order to anchor the rear end 18 of the spacer 16 in place. The center portion 19 has a downward protrusion 19A with an opening 19B to receive the holding pin 9. The front end 17 has a lock finger 17A extending downwardly therefrom. The front end 17 is slightly resilient lengthwise with respect to the holding pin 9.

The upper part 21 of the central lock sleeve 20 has opposed end openings 20A and central opening 20B to receive the holding pins 8 and 9, respectively, and opposed notches 20C on its lower edge 21A to permit the pivot assemblies 7 to pass therethrough. The lower part 22 of the central lock sleeve 20 comprises spring lock fingers 23 below lower edge 21A of the upper part 21 formed by elongated slits 23B in the lock sleeve 20. The spring lock fingers 23 have end lock shoulders 24 and are biased in opposite directions away from the plane of the upper part 21. The spring lock fingers 23 are manually movable sideways at right angles to the plane of the upper part 21 of the central lock sleeve 20 against their normal bias. The outer surface 23A of each spring lock finger 23 (i.e. the surface that faces away from the upper part 21) has a pimple 25 extending therefrom.

The blade assembly 4 at one end 6 of the handle 2 comprises a knife blade 30 having grip knob 30A and a cutting edge 31 and a rear tang 32 with an opening 33 therein to receive the pivot assembly 7. The rear tang 32 has upper and lower lock notches 35 and 36 on each side of the opening 33 and a rear edge 37. The knife blade 30 is pivotally mounted between the inner laminate 15 and lock sleeve 20 and is aligned with spacer 16. The lock finger 17 of spacer 16 is aligned with the tang 32 and particularly with its lock notches or edges 35-36 and rear edge 37.

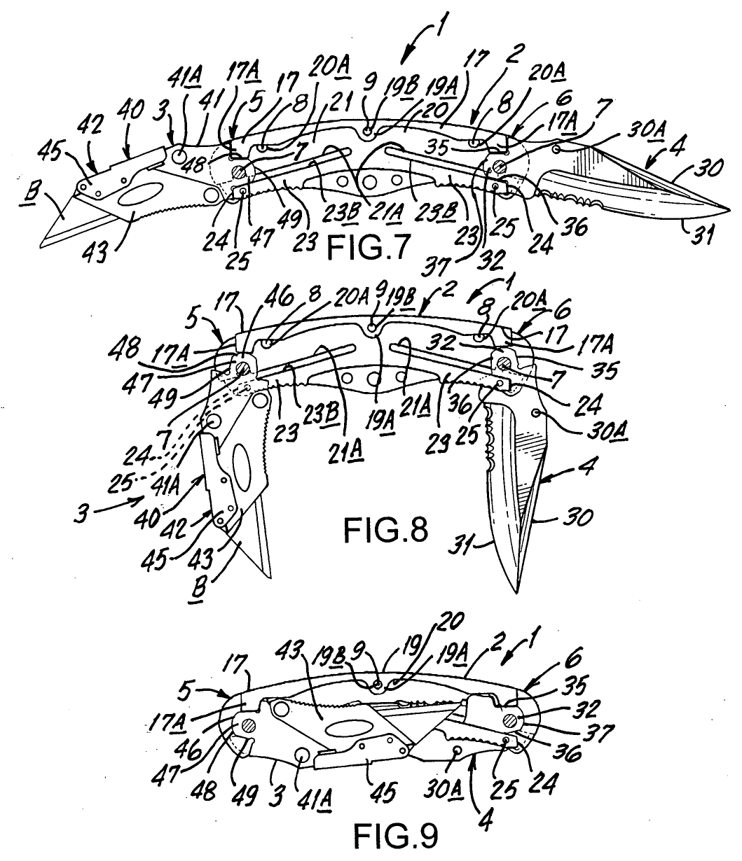

When the blade assembly 4 is in its open position, the lock finger 17A is positioned in the upper lock notch 35 on the tang 32. At the same time the spring lock finger 23 is in its normally outwardly biased position with its lock shoulder 24 aligned with the tang 32 and sitting within the lower lock notch 36 of the tang 32 so that the knife blade 30 is held in its extended position between the lock finger 17A and the lock shoulder 24. When it is desired to fold the blade assembly 4 into the handle 3, the spring lock finger 23 is manually moved sideways against its bias and at a right angle to the plane of the upper part 21 of the central lock sleeve 20 so that its lock shoulder 24 is no longer in alignment with tang 32 and is no longer in lower lock notch 36. This frees the blade assembly 4 to pivot around the pivot 7. As the blade assembly 4 is being pivoted, the tang 32 strikes the lock finger 17A and flexes it upwardly, as shown in FIG. 8. As pivoted movement of the blade assembly 4 continues, the blade assembly 4 moves into the space S in the handle 2 provided by the spacer 16. The lock finger 17A enters the lower lock notch 36 in the tang 32 to hold the blade assembly 32 in place within the space S. At the same time, the outward bias of the spring lock finger 23 causes its pimple 25 to bear against the side of the blade assembly 4 to frictionally assist in holding the blade assembly 4 within the space S.

When it is desired to open or unfold the blade assembly 4, it is rotated around the pivot 7 in the opposite direction. The tang 32 again flexes the lock finger 17A upwardly against its bias until the blade assembly 4 is in its fully extended position, at which point the lock finger 17A again enters the upper lock notch 35 of the tang 32 and the spring lock finger 23 springs back to its normally biased position with the lock shoulder 24 of the spring finger 23 again sitting in lower lock notch 36 of the tang 32 to hold the blade assembly 4 in place in its unfolded position.

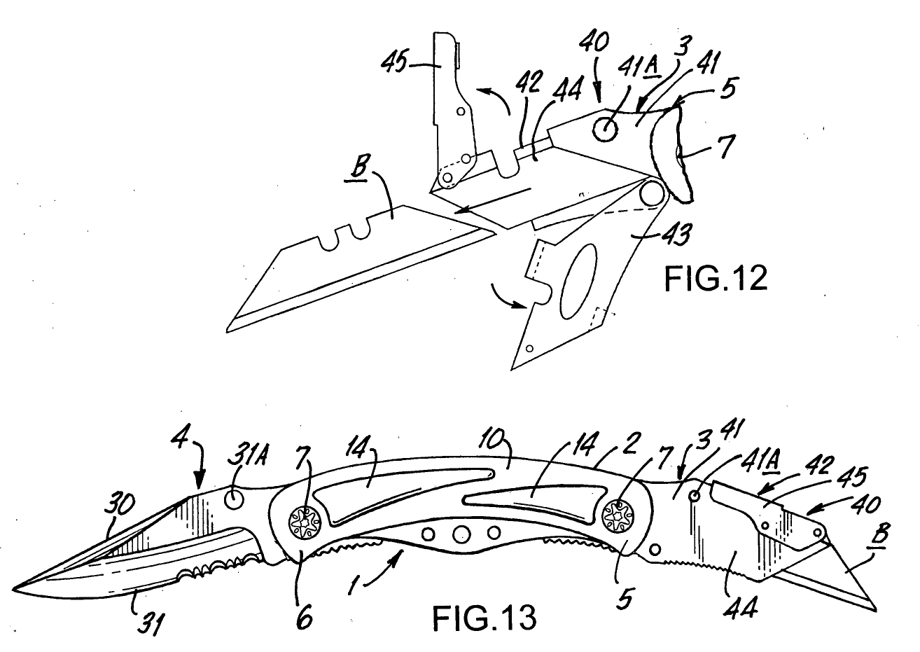

At the other end 5 of the handle 2, the blade assembly 3 comprises a blade holder 40 having a rear end 41 and front end 42. The front end 42 has a guard wall 43 and a main wall 44 between which a blade B is removably mounted (FIG. 12). The guard wall 43 is preferably mounted for pivotal movement relative to the main wall 44. A blade locking assembly 45 (which is preferably u-shaped) is mounted on the blade holder 40 and is pivotally movable from an open position to a closed position. In its open position the guard wall 43 is free to pivot relative to the main wall 44 and permit removal of a blade B. In its closed position the u-shaped blade locking assembly 45 straddles the guard wall 43 and the main wall 44 to hold the guard wall 43 and the main wall 44 together with a blade B therebetween. By opening the blade locking assembly 45, the guard wall 43 is pivoted relative to the main wall 44 to expose the blade B which can be removed and replaced.

The rear end 41 of the blade holder 40 has grip knob 41A and a rearwardly extending tang 46 which has an opening 47 to receive the pivot assembly 7 and has an upper lock notch 48 above the opening 47 and a lower lock notch 49 below the opening 47 and a rear edge 48.

When the blade assembly 4 is in its open unfolded position, the lock finger 17A is positioned in the upper lock notch 48 on the tang 32. At the same time the lock shoulder 24 of the lock spring finger 23 sits within the lower lock notch 49 of the rear tang 46 so that the blade assembly 3 is held in its extended position between the lock finger 17A of the spacer 16 and the lock shoulder 24 of the spring lock finger 23. In this position, spring lock finger 23 is in its normal outwardly biased position. When it is desired to fold the blade assembly 3 into the space S in the handle 2, spring lock finger 23 is manually moved sideways at right angles to the plane of the lock sleeve 20 so that it is no longer in alignment behind the lower lock notch 49. This frees the blade assembly 3 to pivot around the pivot 7. As the blade assembly 3 is being pivoted, the tang 46 strikes the lock finger 17A and flexes it upwardly as shown in FIG. 8. As the pivoted movement of the blade assembly 3 continues, the blade assembly 3 is placed within the space S in the handle 2. The lock finger 17A enters the lower lock notch 49 of the tang 46 to hold the blade assembly 3 in place. At the same time, the bias of the spring lock finger 23 causes its pimple 25 to frictionally bear against the side of the blade assembly 3 to assist in frictionally holding the blade assembly 3 in place in the space S.

When it is desired to unfold the blade assembly 3, it is rotated around the pivot 7 in the opposite direction against the frictional contact of the pimple 25. In this movement, the tang 46 again flexes the lock finger 17A upwardly against its bias until the blade is in its fully extended position, at which point the lock finger 17A again enters the upper lock notch 48 and the lock shoulder 25 of the spring lock finger 23 enters and bears against the lower lock notch 49 to hold the blade holder 3 between them in its extended position.

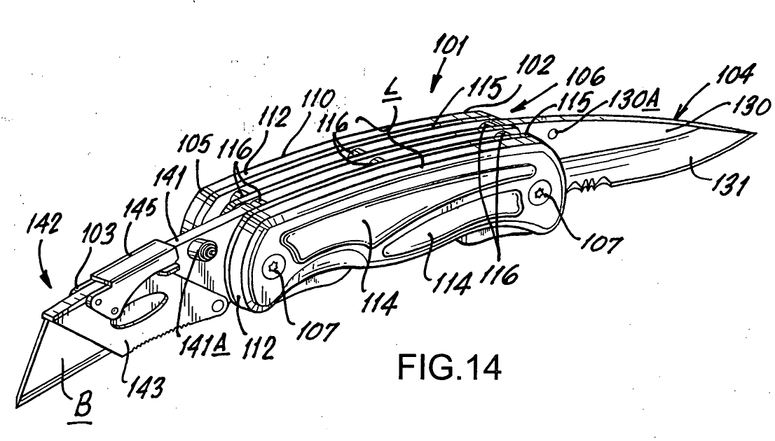

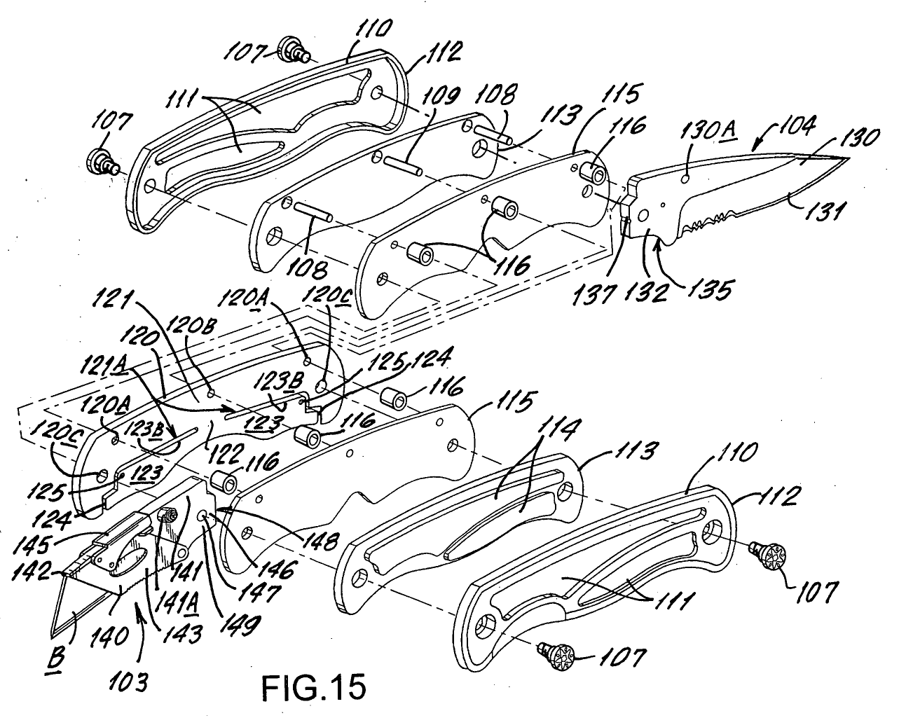

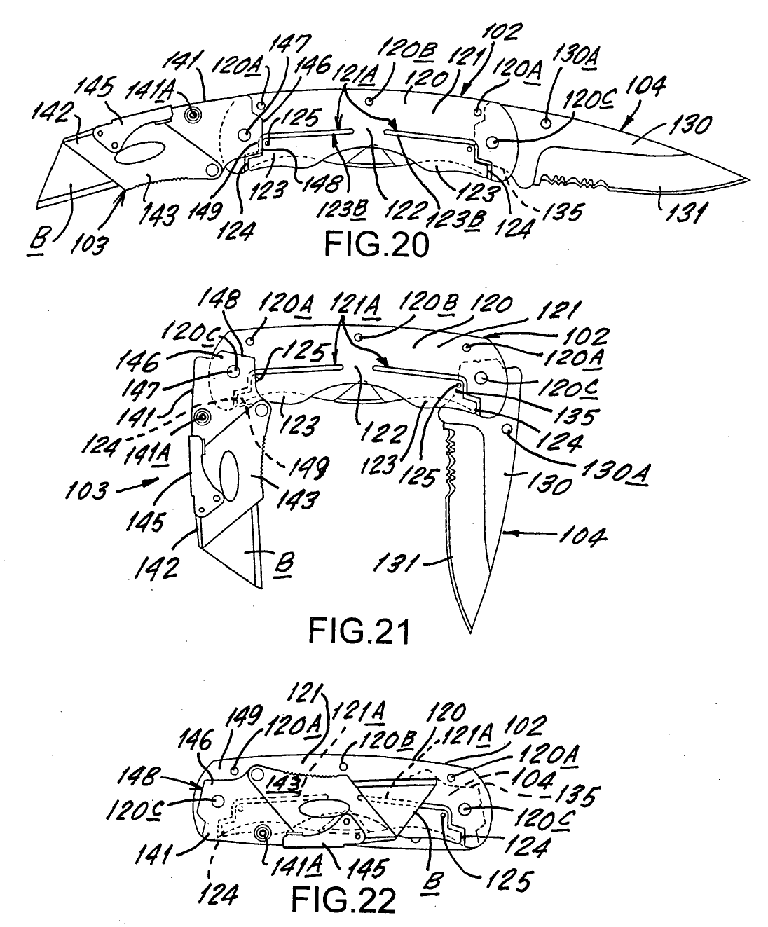

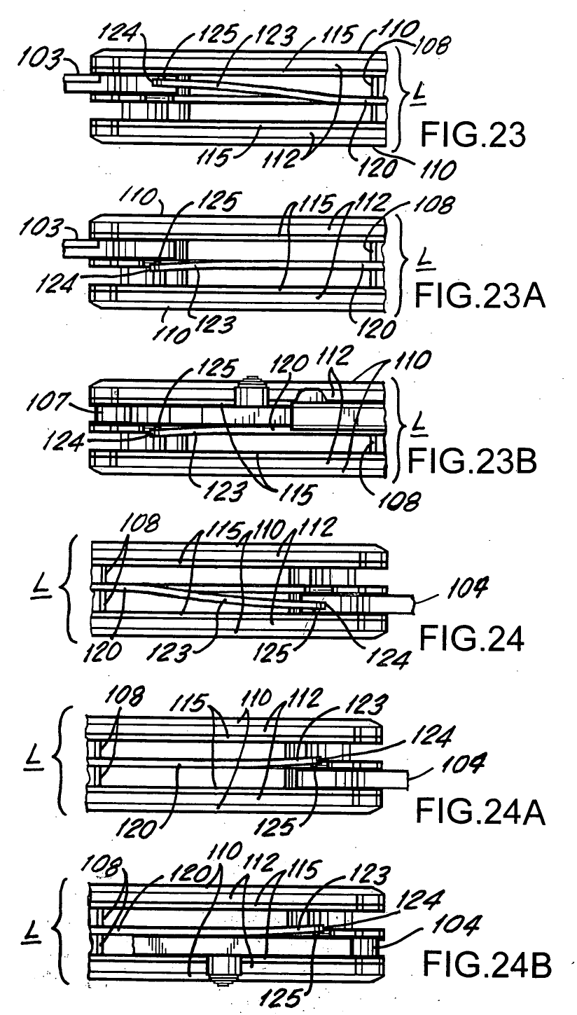

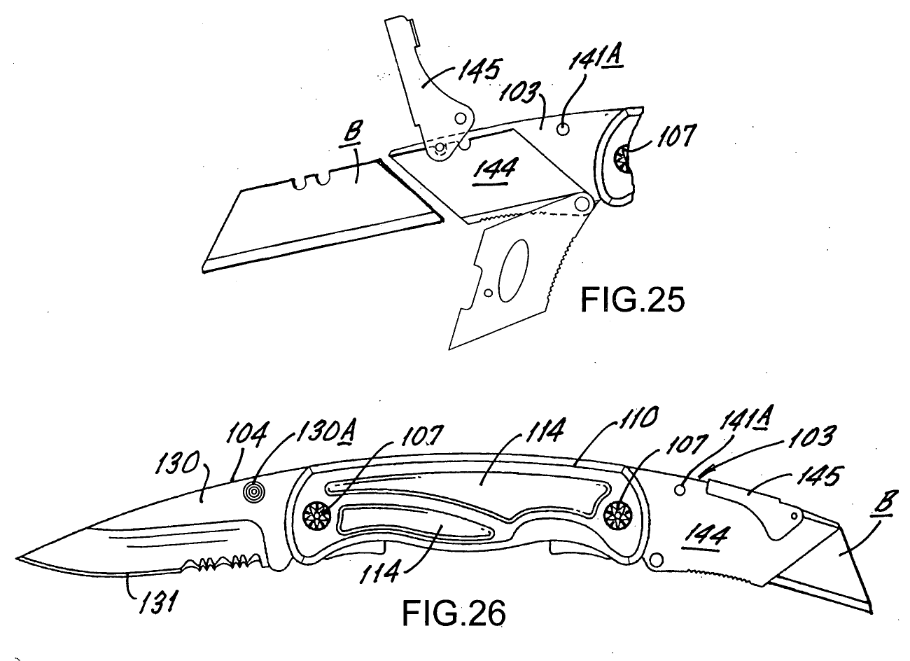

Referring more particularly to the embodiment of the invention shown in FIGS. 14 to 26, the present invention comprises a knife 101 having a handle 102 and a pair of blade assemblies 103 and 104 which are pivotally mounted to opposed ends 105 and 106 of the handle 102 by means of pivot assemblies 107.

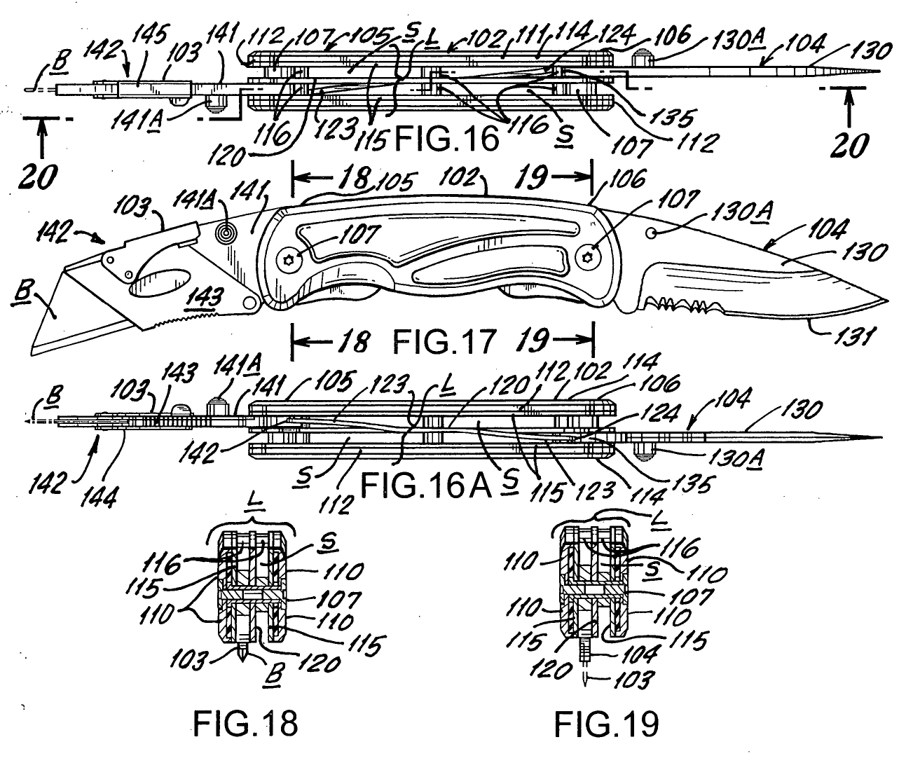

The handle 102 is comprised of a laminate assembly L comprising a plurality of laminates which are held together by the pivot assemblies 107 and by holding pins 108 and 109 which extend through the laminate assembly L. A central lock sleeve 120 is provided at the center of the laminate assembly L. A pair of outer laminates 110 have openings 111 (which may be decoratively shaped) and a peripheral wall 112 adapted to receive therein opposed decorative laminates 113 with raised decorations 114 which extend through the openings 111 in the outer laminates 110 and which fit within the outer wall 112. A pair of opposed inner laminates 115 are provided and bear against the decorative laminates 113. Opposed spacers 116 are mounted between the inner laminates 115 and the center lock sleeve 20 adjacent the upper edge of the laminate assembly L to provide opposed spaces S (FIG. 16A) therebelow within the handle 2 which are adapted to receive the blade tool assemblies 3 and 4 when they are in their folded positions. Each spacer 16 preferably is mounted around the holding pins 8 and 9. The central lock sleeve 120 is interposed between the spacers 116. In brief, the laminate assembly L comprises opposed pairs of laminates 110, 113 and 115 and the spacers 116 on each side of the central lock laminate 120.

The upper part 121 of the central lock sleeve 120 has opposed end openings 120A and central opening 120B to receive the holding pins 8 and 9, respectively, and opposed openings 120C adjacent on its lower edge 121A to permit the pivot assemblies 107 to pass therethrough. The lower part 122 of the central lock sleeve 120 comprises spring lock fingers 123 formed below lower edges 121A of the upper part 121 by elongated slits 123B in the lock sleeve 120. The spring lock fingers 123 have end lock shoulders 124 and are biased in opposite directions away from the plane of the upper part 121. The spring lock fingers 123 are manually movable sideways at right angles to the plane of the upper part 121 against their bias. The outer surface 123A of each spring lock finger 123 (i.e. the surface that faces away from the upper part 121) has a pimple 125 extending therefrom.

The blade assembly 104 at one end 106 of the handle 102 comprises a knife blade 130 having a grip knob 130A and cutting edge 131 and a rear tang 132 with an opening 133 therein to receive the pivot assembly 107. The rear tang 132 has a lower lock edge or notch 135 below the opening 133 and a rear edge 137. The knife blade 130 is pivotally mounted between the inner laminate 115 and lock sleeve 120

When the blade assembly 104 is in its open position, the spring lock finger 123 is in its normally outwardly biased position with its lock shoulder 124 aligned with the tang 132 and sitting within the lower lock edge 135 of the tang 132 so that the knife blade 130 is held in its extended position by the lock shoulder 124. When it is desired to fold the blade assembly 4 into the handle 103, the spring lock finger 123 is manually moved sideways against its bias and at a right angle to the plane of the upper part 121 of the central lock sleeve 120 so that its lock shoulder 124 is no longer in alignment with tang 132 and is no longer in lower lock edge 135. This frees the blade assembly 104 to pivot around the pivot 107. As the blade assembly 104 is being pivoted, the blade assembly 104 moves into the space S in the handle provided by the spacers 116. The outward bias of the spring lock finger 123 causes its pimple 125 to bear against the side of the blade assembly 4 to frictionally assist in holding the blade assembly 4 to within the space S.

When it is desired to open or unfold the blade assembly 104, it is rotated around the pivot 107 in the opposite direction. The spring lock finger 123 springs back to its normally biased position with the lock shoulder 124 of the spring finger 123 again sitting in lower lock edge 135 of the tang 132 to hold the blade assembly 104 in place in its unfolded position.

At the other end 105 of the handle 102, the blade assembly 103 comprises a blade holder 140 having a rear end 141 and front end 142. The front end 142 has a guard wall 143 and a main wall 144 between which a blade B is removably mounted (FIG. 12). The guard wall 143 is preferably mounted for pivotal movement relative to the main wall 144. A blade locking assembly 145 (which is preferably u-shaped) is mounted on the blade holder 140 and is pivotally movable from an open position to a closed position. In its open position the guard wall 143 is free to pivot relative to the main wall 144 and permit removal of a blade B. In its closed position the u-shaped blade locking assembly 145 straddles the guard wall 143 and the main wall 144 to hold the guard wall 143 and the main wall 144 together with a blade B therebetween. By opening the blade locking assembly 145, the guard wall 143 is pivoted relative to the main wall 144 to expose the blade B which can be removed and replaced.

The rear end 141 of the blade holder 140 has grip knob 141A and a rearwardly extending tang 146 which has an opening 147 to receive the pivot assembly 107 and has a lower lock edge 149 below the opening 147 and a rear edge 148.

When the blade assembly 104 is in its open unfolded position, the lock shoulder 124 of the lock spring finger 123 sits within the lower lock edge 149 of the rear tang 146 so that the blade assembly 3 is held in its extended position by the lock shoulder 124 of the spring lock finger 123. In this position, spring lock finger 123 is in its normal outwardly biased position. When it is desired to fold the blade assembly 103 into the space S in the handle 2, spring lock finger 123 is manually moved sideways at right angles to the plane of the lock sleeve 120 so that it is no longer in alignment behind the lower lock edge 149. This frees the blade assembly 103 to pivot around the pivot 107. As the blade assembly 103 is being pivoted, blade assembly 103 continues, the blade assembly 103 is placed within the space S in the handle 102. The bias of the spring lock finger 123 causes its pimple 125 to frictionally bear against the side of the blade assembly 103 to assist in frictionally holding the blade assembly 103 in place in the space S.

When it is desired to unfold the blade assembly 103, it is rotated around the pivot 107 in the opposite direction against the frictional contact of the pimple 125. In this movement, the lock shoulder 125 of the spring lock finger 123 enters and bears against the lower lock edge 149 to hold the blade holder 103 between them in its extended position.

It will thus be seen that the present invention provides an improved knife having blade assemblies pivotally mounted at each end of its handle, in which improved means are provided for holding the blade assemblies in an extended position, which has improved means for holding the blade assemblies in a folded position. The present invention also provided an improved knife in which the blade of at least one of the blade assemblies is easily removable and easily replaceable, which is simple and inexpensive to manufacture and which is simple to use and to maintain.

As many and varied modifications of the subject matter of this invention will become apparent to those skilled in the art from the detailed description given hereinabove, it will be understood that the present invention is limited only as provided in the claims appended hereto.

The embodiments of the invention in which an exclusive Property of privilege is claimed are defines as follows:

1. A knife comprising a handle having a pair of ends, a knife assembly pivotally mounted on each end of the handle for movement from a folded to an unfolded position, said handle having a space therein adapted to receive at least a portion of the knife assemblies when the knife assemblies are in said folded position, each of said knife assemblies having a blade at one end and tang at the other end, said tang having a lock edge thereon, a lock sleeve mounted within the handle, said lock sleeve having a body and a pair of spring lock fingers, said spring lock fingers being biased in opposite directions away from the plane of the body of the lock sleeve, each of said spring lock fingers having a lock shoulder adapted to cooperate with said lock edge of said knife assemblies when the knife assemblies are in their unfolded position to at least assist to hold the knife assemblies in said unfolded position.

2. A knife as set forth in claim 1 wherein said lock shoulder is adapted to sit behind said blade edge.

3. A knife as set forth in claim 2, wherein said spring lock fingers are adapted to be movable against their bias to move away from behind said lock edge and out of said lock edge.

4. A knife as set forth in claim 3, wherein a spacer is provided in said handle to form said space.

5. A knife as set forth in claim 4, wherein the said lock edge of at least one of said tangs comprises an upper lock notch and a lower lock notch.

6. A knife as set forth in claim 5, wherein said spacer has a lock finger at one end and is anchored at the other end, said lock finger being adapted to cooperate with one of said lock notches when the knife assembly is in the unfolded position whereby the knife assembly is held in the unfolded position by the lock finger in one of the lock notches and the lock shoulder cooperating with the other lock notch.

7. A knife as set forth in claim 6, wherein said lock finger is adapted to cooperate with said lower lock notch in the knife assemblies when the knife assembly is in its folded position.

8. A knife as set forth in claim 7, wherein said spring lock finger has a side wall adapted to lie adjacent the side of the knife assemblies when in the folded position to assist in holding the blade assemblies in the folded position.

9. A knife as set forth in claim 8 wherein said side wall of said spring lock finger has a protrusion adapted to bear against the sides of said knife assemblies.

10. A knife as set forth in claim 9, wherein a pair of spaces are provided in said handle, said spaces being removed from each other and being adapted to accommodate the knife assemblies when they are in their folded position.

11. A knife as set forth in claim 10, wherein said lock sleeve is interposed between said spaces.

12. A knife as set forth in claim 11 wherein a pair of spacers are provided to form said spaces with the lock fingers of each spacer facing in opposite directions.

13. A knife comprising a handle having a pair of ends, a knife assembly pivotally mounted on one of said eves for movement from a folded to an unfolded position, said handle having a space therein adapted to receive at least a portion of the knife assembly when the knife assembly is in said folded position, said knife assembly having a blade at one end and tang at the other end, said tang having a lock edge thereon, a lock sleeve mounted within the handle, said lock sleeve having a body and a spring lock finger, said spring lock fingers being biased in opposite directions away from the plane of the body of the lock sleeve, said spring lock finger having a lock shoulder adapted to cooperate with said lock edge of said knife assembly when the knife assembly is in its unfolded position to at least assist to hold the knife assembly in said unfolded position.

14. A knife as set forth in claim 13 wherein said lock shoulder is adapted to sit behind said blade edge.

15. A knife as set forth in claim 14, wherein said spring lock finger is adapted to be movable against its bias to move away from behind said lock edge and out of said lock edge.

16. A knife as set forth in claim 15, wherein a spacer is provided in said handle to form said space.

17. A knife as set forth in claim 16, wherein the said lock edge of said tang comprises an upper lock notch and a lower lock notch.

18. A knife as set forth in claim 17, wherein said spacer has a lock finger at one end and is anchored at the other end, said lock finger being adapted to cooperate with one of said lock notches when the knife assembly is in the unfolded position whereby the knife assembly is held in the unfolded position by the lock finger in one of the lock notches and the lock shoulder cooperating with the other lock notch.

19. A knife as set forth in claim 18, wherein said lock finger is adapted to cooperate with said lower lock notch in the knife assembly when the knife assembly is in its folded position.

20. A knife as set forth in claim 19, wherein said spring lock finger has a side wall adapted to lie adjacent the side of the knife assembly when in the folded position to assist in holding the blade assembly in the folded position.

21. A knife as set forth in claim 20 wherein said side wall of said spring lock finger has a protrusion adapted to bear against the sides of said knife assembly.
